(19) United States
(12) Patent Application Publication
(10) Pub. No.: US 2011/0089162 A1
(43) Pub. Date: Apr. 21, 2011

(54) Induction-Based Heating Appliances Employing Long Wave Magnetic Communication

(75) Inventors: Warren Graber, Hoffman Estates, IL (US); Reinhard Metz, Wheaton, IL (US)

(73) Assignee: Cookek Induction Systems, LLC, a division of Middleby Corporation, Chicago, IL (US)

(21) Appl. No.: 12/580,333

(22) Filed: Oct. 16, 2009

(51) Int. Cl. H05B 6/12

(52) U.S. Cl. 219/627; 219/620

(57) ABSTRACT

Apparatus, methods and systems are provided for measuring and controlling the temperature of a heatable object used to warm or cook food, using transmitters and receivers communicating between each other and/or with heaters, such as induction or direct heaters, using long-wave length magnetic communication (LWMC).

### BACKGROUND OF THE INVENTION

The present invention generally relates to the use of long wave length magnetic communication (LWMC) for sensing the temperature or other parameters of a cooking or warming vessel and communicating this information to the controls of an induction-based heating appliance.

Induction-based heating appliances for cooking or warming food-containing vessels such as pans, buffet trays, pizza carriers, etc., are known.

One method for heating a vessel with a temperature sensor and conveying temperature information to the electronic controls for the induction-based heating appliance is disclosed in U.S. Pat. No. 3,742,178 to Harnden. Harnden discloses a temperature sensor providing a continuous variable voltage signal corresponding to the temperature sensed to a voltage control oscillator that produces a variable frequency signal corresponding to the sensed temperature. A receiver receives radio frequency transmissions of temperature data from the temperature sensor. There are problems with the Harnden approach, in that in order to avoid interference and ensure proper reception, Harnden teaches the use of an output frequency of the feedback signal of at least a megahertz or multiples thereof, which is not a practical solution for an emissions-regulated production appliance.

Another method for providing controlled, induction-based heating of a food-containing vessel is to employ radio frequency identification (RFID) technology, such as disclosed in U.S. Pat. Nos. 6,320,169 and 6,232,585 to Clothier et al. Clothier defines RFID in his patents as an automatic identification technology similar in application to bar code technology, but using radio frequency instead of optical signals, in a typical range of, say, about 13-14 mHz (13.56 mHz being a standard RFID frequency). Clothier advises that RFID systems can be either read-only (a reader with a special “tag” containing an integrated circuit) or read/write (systems permitting 2-way communication between the tag and the reader/writer, with both components typically including electronic memory for storing received information). RFID, using compelled transactions with the tag powered by the transmitting signal, requires a relatively great amount of transmitting power (e.g., ½-1 watt).

RFID technology has limitations in terms of range and performance, as further discussed below. Accordingly, there is a need to provide another form of communication for conveying temperature or other information between a heating/warming vessel and the controls for a heating unit.

In order to overcome the foregoing limitation, a novel approach has been developed in which temperature or other information may be conveyed to a heater, such as an induction-based heater, using not radio frequency electromagnetic waves but rather long wave magnetic communication and signal identification (LWMC) at relatively low frequencies (e.g., less than 500 kHz, and probably in the 130 kHz-455 kHz range). Operation at such low frequencies has the advantage of low power consumption and significantly improved operation near steel and/or water. Unlike RFID which involves a transponding, compelling interaction, LWMC involves autonomous information transmission to the receiver in the induction unit. These features make it relatively easy to deploy LWMC-based devices with sensors, controls, actuators and indicators. Further, the LWMC approach disclosed here need not transmit temperature information as a frequency variation as disclosed in Harnden, but rather may transmit temperature information by pulse width modulation or other digital encoding methods.

LWMC devices may be designed to be bidirectional, on-demand, and peer-to-peer. LWMC transmitters can include sensors (temperature, humidity, jog, etc.), optional displays, and may include a microprocessor with memory, for example. An LWMC transmitter may hold data in its own memory (instead of, or in addition to, having data stored on a server).

LWMC devices can function successfully in difficult environments (i.e., one or both ends of the communication is near steel or water), with networks of many thousands of transmitters, and have a wide range depending on the antenna configuration. LWMC transmitters and receivers are able to function in environments where other radio transmitters/receivers, such as RFID devices, may have problems.

LWMC utilizes very slow, long magnetic waves, also termed inductive communication. James Clerk Maxwell, in his now-famous set of equations (Maxwell's Equations) described what happens when an electron travels along a conductive wire: electric and magnetic fields are created. Virtually all of the energy radiated by a LWMC radio transmitter is contained in the magnetic field, not the electric field, because the antennas are small relative to the wavelength (e.g., about 2.5 km at 131 kHz), and LWMC operates in the near field (i.e., much less than the wavelength of the signal).

LWMC is fundamentally different than, and operates distinctly different from, RFID. RFID operates in a transponding mode, using a transmitter to transmit to a tag, which receives the transmitted signal and sends a signal back. Typically, the tag derives its operating power and power to transmit from the impinging field from the reader's transmit signal. Thus, RFID uses much more power (½-1 watt) than LWMC (microwatts to a few milliwatts).

As one non-limiting example, one form of LWMC employs a relatively new (approved in 2008) IEEE sandard, 1902, also known as RuBee. The RuBee protocol bears similarities to the IEEE 802 protocols which are also known as WiFi, WPAN and Bluetooth, as RuBee is networked by using on-demand, peer-to-peer, active radiating receivers. RuBee, like LWMC in general, uses a low frequency (131 kHz, in the case of RuBee) carrier, with the result that RuBee is very slow (1,200 baud) compared to other packet-based network data standards. This provides twin advantages of ultra-low power consumption (battery life measured in years), and normal operation near steel and/or water. A typical Rubee radio transmitter may include, for example: a 4-bit CPU, a 1 kB sRAM, a crystal, and a lithium battery with an expected life of five years.

The movement and function of radio waves used in RFID are not always predictable because the active environment (people, steel shelves, floors, cabinets, doors) are all part of the same tuned circuit, and change with time. For example, a cell phone call to a phone in a building is modified by steel in the building—maybe reception can be improved by moving the phone near a window, or by pointing the antenna in some hard to predict direction. Many environmental factors influence radio wave performance: steel, water, people, electrical noise sources, etc. Additionally, high frequency (over 1 MHz) RF antennas on or near a steel shelf, for example, have three problems: (1) steel detunes the antenna; (2) RF nulls appear on the shelf with no signal (the so-called Swiss-cheese field) because steel blocks radio waves; and (3) steel reflects radio waves, contributing to communication errors and shelf nulls. In contrast, the relatively low frequency LWMC transmissions (below 1 MHz) are not blocked or reflected by steel so nulls do not occur; also, magnetic loop antennas may be re-tuned with external capacitors, and circuits can be created that dynamically pick the optimal external capacitor for the antenna.

The medium for LWMC transmission—magnetic waves—can pass through almost anything, even rock. That same rock blocks radio waves (RFID) after only a few feet. (LWMC is 99.99% magnetic waves and is therefore not affected at all by people, animals, mud or water, while steel can actually enhance the magnetic signal.) An RFID signal falls off as 1/r, while magnetic wave strength falls off far faster, at the rate of 1/r³. This difference in fall-off rate may appear as a negative, but it is actually a positive in the environment of a local visibility network. Also, an unexpected advantage is that the noise LWMC sees is also magnetic, so it too falls off at 1/r³. In other words, in an LWMC environment, noise and interference sources must be much more local to have significant strength, and tend to be easier to locate and minimize.

LWMC advantages thus include: long battery life; the transmitter/receiver data can travel with the asset (i.e., because data may be stored in the transmitter, the reader can simply read a LWMC transmitter without having to go to an IT system to look it up); safety (a LWMC transmitter only produces milliwatts of radiated energy, and LWMC magnetic waves are not absorbed by biological tissues, do not affect pacemakers, and are not regulated by OSHA); high security and privacy (the eavesdropping range is the same as the transmitter range, so if someone is listening, they must be close enough to be seen, unlike RFID or 802 protocols; LWMC transmitters can also use strong encryption; controlled range; cost effectiveness; and reduced susceptibility to extraneous noise.

### Definition of Claim Terms

The following terms are used in the claims of the patent as filed and are intended to have their broadest meaning consistent with the requirements of law. Where alternative meanings are possible, the broadest meaning is intended. All words used in the claims are intended to be used in the normal, customary usage of grammar and the English language.

“Closed-loop” means an operation influenced or controlled by the effect it has on a measured parameter. For example, a temperature sensor may be used to control heating in a closed-loop operation. In contrast, heating a pot over an open flame in the traditional manner is an example of an “open-loop” operation. (Pot heating may be influenced by initial room temperature, for example.)

“Cookware” means cooking, serving or delivery containers for food, including but not limited to dishes, pots, trays including buffet trays and warming trays, etc.

“Direct heater” or “Direct heating” or “Direct heating system” means a heater or method of heating, or system involving such heating, respectively, in which food contained by an item of cookware or other cooking, serving or delivery food container, is heated through conduction of heat from the cookware or container to the food, and the temperature of the cookware or container is sensed to control the heating.

“Food” means any item or material which may be normally ingested by humans, including solid or liquid matter.

“Indirect heater” or “indirect heating” or “indirect heating system” means a heater or method of heating, or system involving such heating, respectively, in which food contained by an item of cookware or other cooking, serving or delivery food container, is heated through conduction of heat from the cookware or container to the food, and the temperature of the cookware or container is sensed to control the heating. One method of indirect heating is induction heating, in which the induction heater temperature controls are located remote to a temperature sensor that is associated with a food-containing vessel.

“LWMC” means long wave magnetic communication in frequency ranges below about 500 kHz. LWMC includes, but is not limited to, long wave magnetic communications employing the IEEE standard 1902, also known as RuBee. LWMC is distinct and different from RFID in its frequency range of use.

“LWMC transmitter” means a device possessing information relevant to the heating of cookware or other cooking-, serving- or delivery-related food containers, that is capable of transmitting sensor information such as but not limited to temperature, humidity, volume or weight to a receiver associated with heating controls of a heater, where such communication occurs through the mode of LWMC.

“LWMC receiver” means a device capable of receiving information from a LWMC transmitter relevant to the heating of cookware of other cooking-, serving-, or delivery-related food containers, which information is communicated to heating controls associated with a heater using the communication mode of LWMC. The LWMC receiver may be unidirectional in the sense of being incapable of transmission, or it may be an active transceiver that is also capable of transmitting signals.

### SUMMARY OF THE INVENTION

The objects mentioned above, as well as other objects, are solved by the present invention, which overcomes disadvantages of prior communication methods, such as RFID, for communicating transmitter information to the controls of a heating unit, while providing new advantages not previously obtainable with such heating systems.

In a preferred embodiment, apparatus for measuring and controlling the temperature of a heatable object used to warm or cook food is provided. Preferably, a LWMC transmitter may be operably connected to the heatable object, for receiving and transmitting information concerning one or more parameters describing the heatable object, such as temperature (a temperature-sensitive switch may be used for this purpose). A LWMC receiver may be associated with a heater. The LWMC transmitter may communicate information concerning one or more of the heatable object parameters to the LWMC receiver, and the LWMC receiver may communicate controls to the heater based on the one or more heatable object parameters.

One heater which may be used is an induction heater which transmits magnetic waves to the heatable object. In this manner the transmitter may be powered by a magnetic field generated by the induction heater. Alternatively, the heater may be a direct heater (e.g., electric- or gas-powered). The LWMC transmitter may be magnetically coupled to and detachable from the heatable object.

A trivet may be employed which is in contact with the heatable object. As an example, the trivet may rest on a countertop and act as an insulator to limit the amount of heat transferring from the heatable object through the trivet to the countertop. The heater may be located below the countertop, and the apparatus may indicate to the user (e.g., by powering an LED or other indication means) when the cookware is properly located over the induction heater, and also whether the induction heater is currently heating the heatable object. The LWMC transmitter and associated electronic circuitry may be located within channels or cavities on the underside of the trivet.

The heatable object may be a vessel used to warm or cook food, such as but not limited to: a cookware item (e.g., a pot, pan or other cooking dish); a buffet warming tray; a pellet; or a pizza warming box.

A magnetic detachable coupler may be used to carry the LWMC transmitter. The coupler may be removably attached to the heatable object. In one preferred embodiment, the magnetic coupler includes a housing in which the transmitter is located, and a tongue portion having a temperature sensor. In this embodiment, the tongue portion may be in abutting contact with the heatable object when the magnetic coupler is magnetically coupled to the heatable object.

An antenna may be associated with the heater to facilitate communication between the LWMC transmitter and the LWMC receiver. The housing of the magnetic detachable coupler, for example, may have a length sufficient to allow positioning of the transmitter within the housing at a location which is within a reception area of the antenna.

Adhesive means, such as double-sided adhesive tape, may be attached to the coupler, permitting the LWMC transmitter to be attached to non-metal heatable objects.

The LWMC transmitter may have an electronic memory capable of storing electronic information pertaining to the heating history previously experienced by the heatable object. The LWMC transmitter may also be capable of transmitting information when interrogated by the LWMC receiver, and storing updated information received by the transmitter.

In another embodiment of the present invention, an apparatus is provided for measuring and controlling the temperature of a heatable object used to warm or cook food. In one embodiment, a magnetic induction heater includes a magnetic field generator for generating a magnetic field. The heater also has a LWMC receiver and a LWMC transmitted associated with it, as well as a microprocessor operably connected with the LWMC receiver for initiating the heating of the object only upon placement of the object proximal to the heater and in a position for LWMC communication between the transmitter and the receiver. The microprocessor allows control over operation of the heater in response to information received from the LWMC transmitter. Again, the heatable object may include a food-holding container and an induction heating element (such as a pellet). In one embodiment, the microprocessor permits initiation of different heater operation sequences in response to the information received from the LWMC transmitter.

In still another embodiment of the invention, a method is provided for heating an object containing food. In this method, a magnetic induction heater is provided, which includes a magnetic field generator for generating a magnetic field. The heater preferably has a LWMC receiver associated with it. An object to be magnetically heated is also provided, including an induction heatable element and an LWMC transmitter. The object may be placed proximal to the heater in a location for magnetic induction heating of the element and in a position for LWMC communication between the transmitter and the receiver. Heating of the object is initiated; heater operation may be controlled in response to the placement of the object and receipt of information from the LWMC transmitter. The initiating and controlling steps may be carried out by a microprocessor programmed to initiate different heater operation sequences in response to information received from the transmitter.

In yet another embodiment of the invention, a food delivery system is provided, which includes a food-holding container including an induction heatable element, and a magnetic induction heater including a magnetic field generator for generating a magnetic field. The heater is preferably operable to heat the element while the element is magnetically coupled with the magnetic field and the element remains within the container. A temperature controller may be used to control the temperature of the element during the course of heating of the element, including a detector operable to detect an induction heater circuit parameter whose magnitude is dependent upon the impedance presented by the heating element when the element is magnetically coupled with the magnetic field. Control circuitry is preferably used to alter the magnetic field strength of the magnetic field in response to the magnitude, or rate of change of the magnitude, of the detected parameter, during the course of heating. The temperature controller preferably communicates with the heater using LWMC magnetic communication.

In a further embodiment of the invention, apparatus is provided for measuring and controlling the temperature of an object to be heated used to warm or cook food. The apparatus may include: a LWMC transmitter operably connected to the heatable object; a LWMC receiver associated with a heater; a transmitting coil for receiving a sine wave modulated signal and for transmitting the signal over a magnetic field; a receiving coil for receiving the sine wave modulated signal transmitted by the transmitting coil; electronic circuitry for demodulating the signal received by the receiving coil; and a processor for extracting the temperature of the heatable object from the pulse width of the demodulated signal. Preferably, the transmitter and the receiver communicate using LWMC.

In still another embodiment of the invention, a detachable apparatus is provided for measuring the temperature of an object to be heated, providing for closed-loop heating control. An item of cookware to be heated is provided, which includes a LWMC transmitter capable of communication with a LWMC receiver in communication with heating controls (which may be direct heating or induction-based heating). A magnetic detachable coupler carrying the transmitter may also be provided, and permits removable attachment of the coupler to the heatable object.

In a preferred embodiment, a distribution system of gain and filtering may be provided. In a particularly preferred embodiment, the distribution system includes a capacitor in parallel with an antenna coil which tunes the antenna as a L-C parallel resonant circuit at the LWMC frequency, enabling selection of desired induction field signals for an induction heater associated with the LWMC transmitter and the LWMC receiver, and enabling rejection of induction field signals associated with adjacent induction heater units.

In another preferred embodiment, a transmission modulation and demodulation system may be provided for enabling the LWMC receiver to sufficiently differentiate the LWMC transmitter from transmitters associated with adjacent heater units. This system may envelope-detect a received signal using a peak detector that follows the temperature modulation, but filters out the LWMC carrier frequency associated with transmitters of the adjacent heater units.

In still another embodiment, a protection circuit may be provided and designed to avoid damaging the LWMC transmitter in the event that the induction heater is connected to a power source greater than the heater is designed for. The protection circuit may include a power-deriving coil, a rectifier, and a voltage pre-regulator.

In still another embodiment of the invention, apparatus is provided for measuring and controlling the temperature of a heatable object used to warm or cook food. The apparatus may include: a LWMC transmitter operably connected to the heatable object, for receiving and transmitting information concerning one or more parameters describing the heatable object; a LWMC receiver associated with an induction heater, the LWMC transmitter communicating information concerning one or more of the heatable object parameters to the LWMC receiver, and the LWMC receiver communicating controls based on the one or more heatable object parameters to the heater; an induction heater generating an induction field; and a power pickup coil receiving energy from the induction field and powering a temperature sensor coupled to a low frequency oscillator and an amplifier, the oscillator generating a modulated signal amplified by the amplifier and used to drive a low frequency magnetic field transducer coil for generating long wave magnetic communication. In preferred embodiments, the transducer coil may include a ferrite core, and the induction unit may include the induction heater and a receiving coil for receiving and transmitting induction heating-related data to an induction unit control processor.

### BRIEF DESCRIPTION OF THE DRAWINGS

The novel features which are characteristic of the invention are set forth in the appended claims. The invention itself, however, together with further objects and attendant advantages thereof, will be best understood by reference to the following description taken in connection with the accompanying drawings, in which:

FIG. 1 is a schematic view of one preferred embodiment of the present invention, in which LWMC communication may be employed to provide information such as the temperature of a warming/cooking vessel to the electronic controls of an induction heating unit;

FIG. 2 is a schematic diagram of one embodiment of the electronics which may be used to provide the LWMC communication and induction heating for the system shown in FIG. 1;

FIG. 3 is a schematic diagram of preferred embodiment of the electronics suitable for use in a buffet warming system;

FIGS. 4 and 5 are schematic diagrams of transmit and receive coils, respectively, which may be used for the buffet warming system shown in FIG. 3;

FIG. 6 is a schematic diagram of an induction heating system for a cooking/warming vessel in which a countertop is located between the cookware and the heater;

FIG. 7 is an enlarged top and side perspective view of a portion of the embodiment shown in FIG. 7, showing the LWMC transmitter circuit;

FIG. 8 is an enlarged perspective view of a portion of the embodiment shown in FIG. 7, showing the LWMC receiver circuit;

FIG. 9 is a top and side perspective view of an alternative preferred embodiment of the LWMC-controlled, induction-based heating device, showing the induction heater with the LWMC receiver antenna on top;

FIG. 10 is a schematic view of a preferred embodiment for distributing gain and filtering, allowing the LWMC receiver to communicate only with the induction field of the heater associated with that receiver, as opposed to adjacent induction fields associated with other, adjacent heater units;

FIG. 11 is a schematic view of a preferred embodiment enabling an LWMC receiver to differentiate its intended transmitter from adjacent transmitters associated with adjacent heater units; and

FIG. 12 is a schematic view of a preferred embodiment for avoiding damage to an LWMC transmitter which is inadvertently placed on a higher-powered unit than the transmitter has been designed for.

The components in the drawings are not necessarily to scale, emphasis instead being placed upon clearly illustrating the principles of the present invention.

### DETAILED DESCRIPTION OF THE PREFERRED EMBODIMENTS

Set forth below is a description of what are believed to be the preferred embodiments and/or best examples of the invention claimed. Future and present alternatives and modifications to this preferred embodiment are contemplated. Any alternatives or modifications which make insubstantial changes in function, in purpose, in structure, or in result are intended to be covered by the claims of this patent.

The LWMC communication modes useful as described here may be powered by the induction magnetic field of a heating appliance. For example, the induction heating system disclosed in U.S. Ser. No. 11/869,822, filed Oct. 10, 2007 and titled “Food Warming Device And System” (“the '822 application”), the entirety of which is hereby incorporated by reference herein, employs a circuit that derives power from the induction field that powers an LED-based field location/indication function. This power could also be used to power a circuit that measures the temperature of a cooking/warming vessel placed over the circuit, and sends that temperature information using LWMC to the induction unit's control circuitry. This technology can also be used to indicate to the user when the cookware is properly located over the induction heating unit (such as when a stone countertop lies between them), and also to indicate whether the heating unit is currently heating.

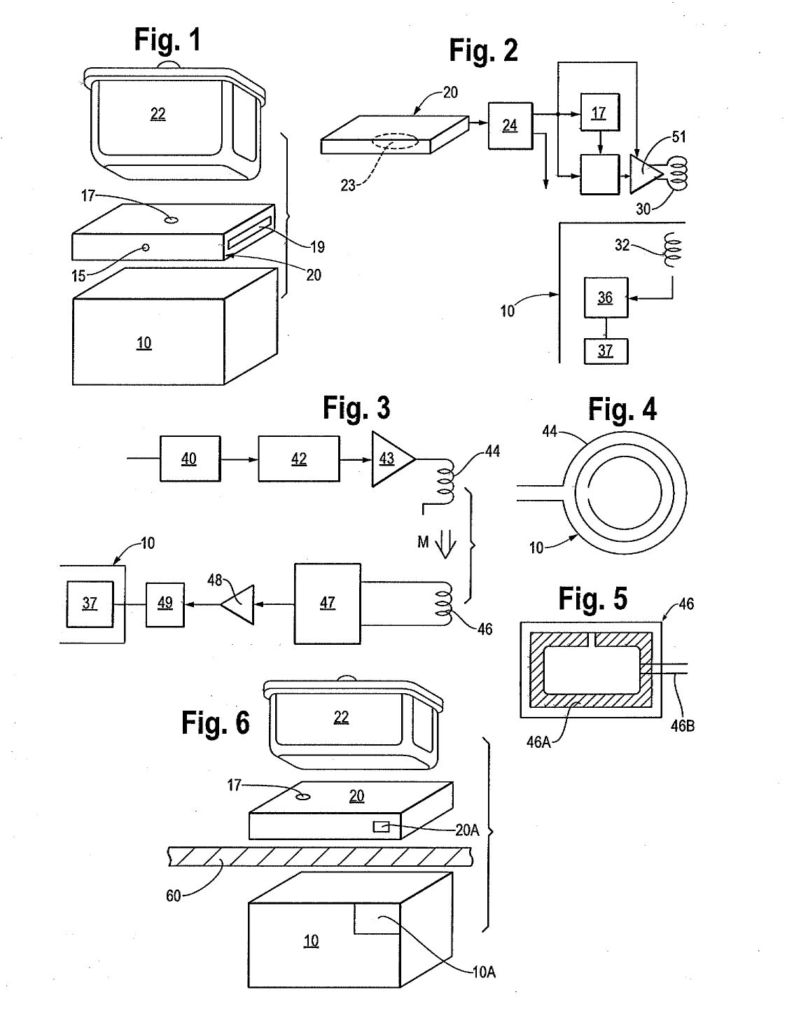

Referring first to FIG. 1, a preferred embodiment according to the present invention is now described. FIG. 1 shows an induction heating system similar to that disclosed in the '822 application. In one embodiment, a trivet 20 may be placed over an induction heating unit 10, for warming or cooking a pot or other vessel 22. Trivet 22 may include a temperature sensor 17, electronics 19 for LWMC communication of temperature or other data, and an in-field position indication light 15.

Referring now to FIG. 2, one preferred form of the electronics for use with LWMC communication is disclosed. In this embodiment, a power pickup coil 23 in the induction field may be used to pick up energy and supply it to a power supply 24 which powers a temperature sensor 17, a low frequency oscillator 27, and amplifier 51. The data from temperature sensor 17 (and possibly other data) is used to pulse width modulate a low frequency magnetic field (LWMC) using oscillator 27, temperature sensor/data modulator 17, and amplifier 51 driving a low frequency magnetic field transducer coil 30, potentially including a ferrite core. At induction unit 10, this modulated magnetic field may be received by a receiving coil 32, filtered, amplified, and demodulated at 36, and the data may be provided to the induction unit control processor 37.

This LWMC approach may utilize but does not require a transponding approach, as with RFID. The sensor may just send the data to the receiver autonomously. Also unlike RFID, the LWMC approach does not rely on electromagnetic radio frequencies, but rather uses a magnetic low frequency field.

Tests were performed to further develop the magnetic temperature/data communication system described above. For example, referring now to FIG. 3-5, a transmitting coil 44 (FIG. 4) and a receiving coil 46 (FIG. 5) were made, and driven with a sine wave in a frequency range of 20 kHz to 455 kHz. The received signal, using a practical coil and typical winding distance for the buffet warming system, was deemed acceptable for the proposed communications, in the face of the high magnitude magnetic induction fields.

Tests were performed in a frequency range of 40 kHz to 455 kHz with good communication results and practical transmitting and receiving coils. The transmitting coil 44 (FIGS. 3-4) that was tested included 75 turns on a one-inch diameter bobbin (for winding wire) mounted in the trivet disclosed in the '822 application. The receiving coil 46 (FIGS. 3 and 5) included 14 turns around the periphery of induction unit 10, in a manner suitable for printed circuit board implementation.

It was found that an Analog Devices TMP 04 or equivalent temperature sensor provides a low frequency pulse width modulating output, where pulse width conveys temperature. This may be used to modulate the sine wave, which may be amplified and provided to transmitting coil 44. Referring back to FIG. 3, receiving coil 46 within induction unit 10 receives the modulated sine wave signal from transmitting coil 44, which is carried over magnetic field M. This signal may then be provided to a filter/limiter circuit 48, after which it may be demodulated (peak detected) at 49. Then, processor 37 (FIG. 2) may be used to extract the temperature from the pulse width. Other data may be transmitted by similar means.

Referring now to FIG. 6, in addition to or alternative to the magnetic communication methods described above, another approach to communication between an induction cooking/warming appliance 10 and a cooking/warming vessel 22 separated by a stone surface 60, for example, may be provided. In this embodiment, data communication/temperature measuring device 17, which may be integrated or attached (such as located on trivet 20) or separate thereto, may be provided in conjunction with an LWMC (e.g., IEEE 1902.1 Rubee) protocol and/or magnetic communications technology, hardware and software. Thus, LWMC transmitter 20A may include a sensor, power circuits and data capabilities, while induction heating unit 10 may include an LWMC (e.g., Rubee IEEE 1902.1) receiver 10A.

As mentioned above, LWMC transmitter 20a may be integrated or attached to trivet 20 or heating/cooking vessel 22. In one preferred embodiment, the LWMC transmitter may be magnetically coupled to and detachable from the trivet or vessel as disclosed in U.S. Ser. No. 11/750,571, filed May 18, 2007 and titled “Detachable Transmitter-Based Temperature Sensor For Use In Heating Of Food And Cookware” (“the '571 application”), the entirety of which is hereby incorporated by reference herein.

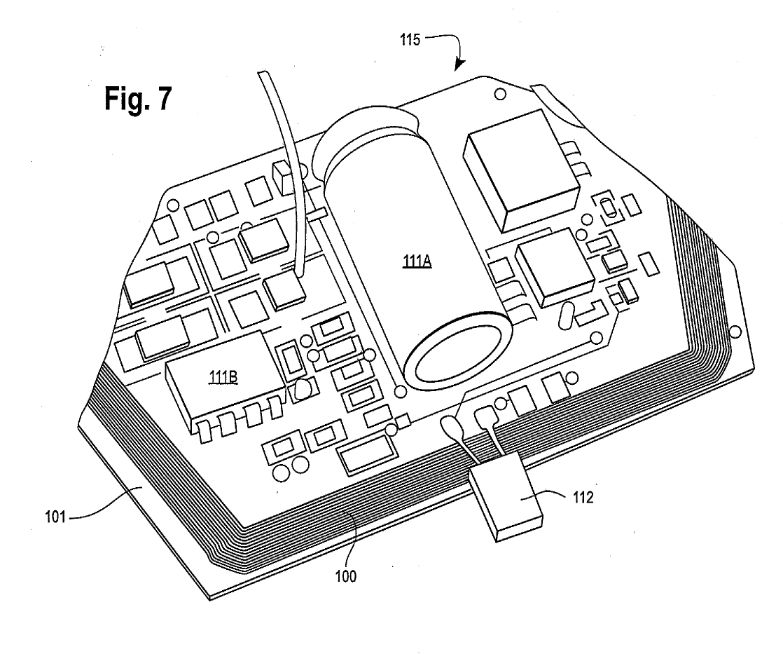

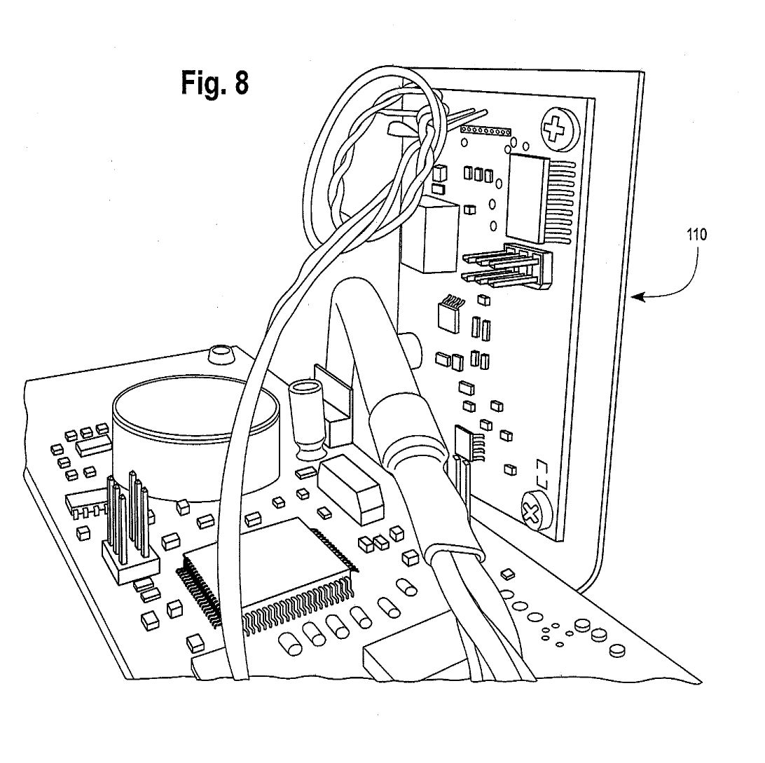

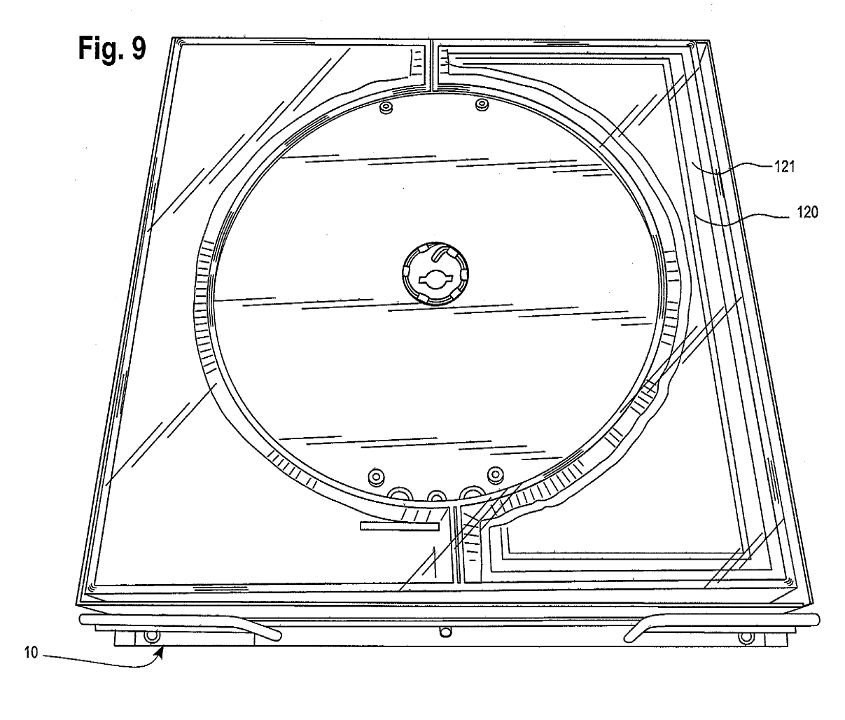

Referring now to FIGS. 7-9, an alternative embodiment of the invention is shown. As in the above embodiment, the LWMC magnetic field may be powered by the induction field generated by induction heater 10. FIG. 9 shows an LWMC transmitting antenna coil 120 sitting on top of induction heater 10. LWMC antenna coil 120 may be used to transmit long magnetic waves (LWMC), and may be printed directly on circuit board 121, which may act as a receiver. Circuit board 121 may be of a type as disclosed in the '822 application or the '571 application. Antenna 120 may be driven by electronics contained within LWMC transmitter 115 (FIG. 7), and may be in electrical communication with receiver 110 (FIG. 8), LWMC power supply components 111A and 111B, and position-indicating LED 112, all of which form LWMC power supply, temperature measurement and transmitter circuit 115 (FIG. 7).

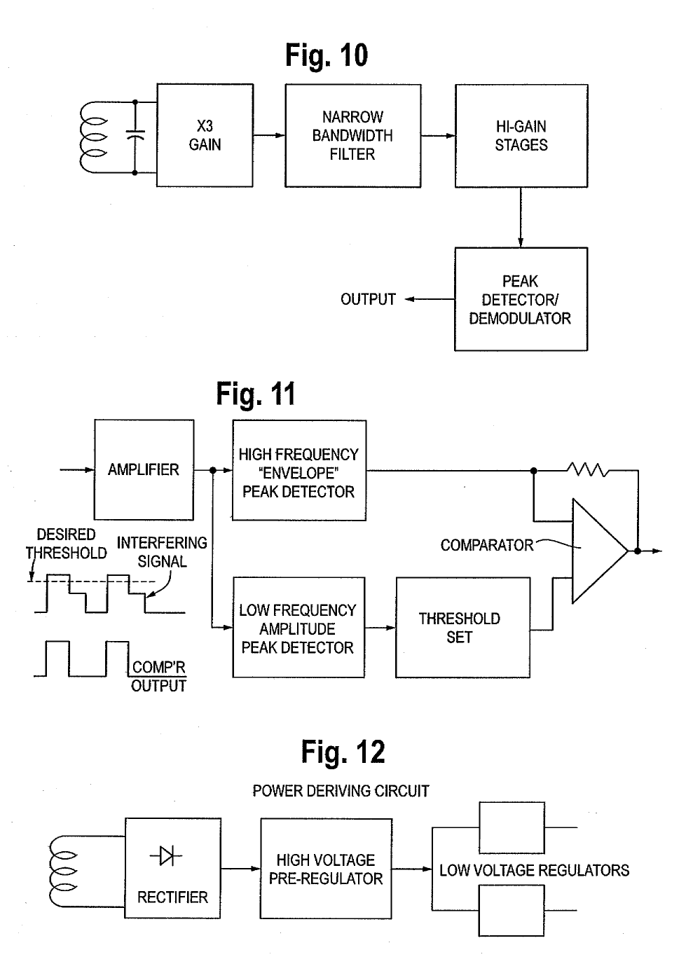

Low frequency communication in the context of induction can encounter several problems. For example, when multiple induction cooking/heating/warming units are operated in close proximity, the LWMC control for one induction heater should not communication with an adjacent induction heater. More specifically, the receiver in any one unit may pick up the induction field of adjacent units, which can easily overload the receiver. This problem may be overcome by a carefully chosen distribution of gain and filtering. An exemplary way to accomplish this is shown in FIG. 10. Here, a capacitor in parallel with the antenna coil tunes the antenna as a L-C parallel resonant circuit at the LWMC frequency. The voltage that appears across the antenna/capacitor circuit combination will be maximized at the tuned frequency, acting as a selective filter for that tuned frequency. This enables selection of the desired induction field signals for the desired transmitter associated with the heater unit, and a corresponding rejection of induction field signals of adjacent heater units. This may be followed by a low gain broadband amplifier stage that may also impedance match to a 4^{th} or 6^{th} order band pass filter at the LWMC frequency. The possible interfering induction frequencies are then at this point attenuated sufficiently to follow with the high gain stages where the signal is amplified further. This may, in turn, be followed by the peak detector/demodulator to extract the signal to be used by subsequent processing to determine the temperature.

Another potential issue for multiple adjacent units is that it is possible for the multiple LWMC systems to interfere with each other. Specifically, one transceiver may not sufficiently differentiate its intended transmitter from an adjacent transmitter. One solution to this problem lies in the transmission modulation technique and the demodulation approach. More specifically, the LWMC-transmitted signal may be analyzed by the LWMC receiver, looking for peak values. The receiver may be designed to only recognize the peak signal from the closest transmitter (e.g., the closest trivet). The magnetic fields generated by the induction fields of adjacent units may be rejected using bandpass filtering. Referring to FIG. 11, one preferred embodiment of such a system is disclosed. The transmitter may be designed to encode the temperature information as pulse width amplitude modulation of the transmit frequency. Then, at the receiver, the amplitude signal is low and the high frequency peak detected, as shown in FIG. 11. The received signal may be envelope-detected (i.e., by generating a signal which represents the peak maximum outline of the LWMC carrier frequency signal) using a peak detector that follows the temperature modulation, but filters out the LWMC carrier frequency. The second low frequency peak detector has a longer time constraint and essentially filters out the temperature modulation and develops a peak representative of the overall signal. From this, a threshold is derived that is just below this peak. The envelope-detected signal is then compared to this threshold, and the temperature modulation results at the output.

Note that with the system shown in FIG. 11, the envelope peak-detected signal may contain both the desired local transmitter's signal as well as the contribution of any adjacent unit's transmitters. However, these latter components will inherently be of a lower amplitude, and since the threshold for detection is set by the peak signal, these will be ignored in the comparison stage. In general, the signal from adjacent transmitters will be of significantly lower amplitude, but this method of peak detection and comparison has been shown to be able to completely reject the contribution of alternative transmitters up to very close to even signal levels. This is in contrast to an alternative, prior method where, for example, the temperature information is encoded as the frequency modulation of a carrier, in which case the signal contributions of adjacent transmitters would mix in such a way that the receiver would not be able to distinguish them.

Another potential problem with low frequency communication in the context of induction heating is that users may attempt to use the LWMC transmitter (trivet) on an induction unit of too high a power output. To avoid damage to components such as the transmitter and/or the power-deriving circuit, a protection circuit has been designed and also forms part of the present invention. This protection circuit is designed to quickly limit power to the LWMC circuitry if the induction field strength is too large and potentially damaging. Conversely, the induction power-deriving circuit that powers the transmitter must be able to derive sufficient power when immersed in the field of, for example, a relatively low powered inverter, such as a 600 W unit. As an example, a typical “wide” voltage range power circuit, such as a laptop “world voltage” range power supply, will typically accommodate a range of, for example, 2½ or 3 (100-240V, or 85-265V). Here, the range can easily be as high as 6 or 7 to 1 (trivets are typically used on an induction unit of 600 W; induction units of 3500-4000 W are also available), and it is highly desirable not to damage a transmitter in this circumstance. In one preferred design, avoiding damage to a transmitter in this circumstance may be accomplished as shown in FIG. 12. Following the power deriving coil and rectifier, a high voltage pre-regulator may be used (e.g., Texas Instruments Part # TL783), with high voltage parts, that can accommodate up to the highest input voltage, and regulate down to a level acceptable to the lower voltage power supply regulators, thereby protecting them.

The LWMC-controlled, induction-based heater of the present invention is more reliable and less sensitive to metal (e.g., metal pans, etc.) than RFID-controlled, induction-based heaters. The use of a magnetic field rather than an electric field provides better range, power and performance. For example, RFID transmitters typically transmit powers in the range of a few hundred milliwatts to about 1 W; LWMC transmitters may transmit powers in the range of microwatts to a few milliwatts. In addition, the LWMC communication mode provides the ability to automatically reject adjacent units, as now explained.

The induction heater may also be battery-powered for portability.

The above description is not intended to limit the meaning of the words used in the following claims that define the invention, and persons of ordinary skill in the art will understand that a variety of other designs still falling within the scope of the following claims may be envisioned and used. It is contemplated that future modifications in structure, function or result will exist that are not substantial changes and that all such insubstantial changes in what is claimed are intended to be covered by the claims.

We claim:

1. Apparatus for measuring and controlling the temperature of a heatable object used to warm or cook food, comprising:
a LWMC transmitter operably connected to the heatable object, for receiving and transmitting information concerning one or more parameters describing the heatable object; and
a LWMC receiver associated with a heater, the LWMC transmitter communicating information concerning one or more of the heatable object parameters to the LWMC receiver, and the LWMC receiver communicating controls to the heater based on the one or more heatable object parameters.

2. The apparatus of claim 1, wherein the heater comprises an induction heater which transmits magnetic waves to the heatable object, and wherein the transmitter is powered by a magnetic field generated by the induction heater.

3. The apparatus of claim 1, wherein the heater comprises a direct heater.

4. The apparatus of claim 1, wherein the LWMC transmitter is magnetically coupled to and detachable from the heatable object.

5. The apparatus of claim 2, further comprising a trivet in contact with the heatable object, the trivet resting on a countertop and acting as an insulator to limit the amount of heat transferring from the heatable object through the trivet to the countertop.

6. The apparatus of claim 5, wherein the heater is located below the countertop, and the apparatus indicating to the user when the cookware is properly located over the induction heater, and also to indicate whether the induction heater is currently heating the heatable object.

7. The apparatus of claim 1, wherein the heatable object comprises a vessel used to warm or cook food.

8. The apparatus of claim 7, wherein the vessel includes one or more of the following: a cookware item such as but not limited to a pot, pan or other cooking dish; a buffet warming tray; a pellet; or a pizza warming box.

9. The apparatus of claim 4, further comprising a magnetic detachable coupler carrying the LWMC transmitter, the coupler being removably attached to the heatable object.

10. The apparatus of claim 9, wherein the magnetic coupler comprises a housing in which the transmitter is located, and a tongue portion having a temperature sensor.

11. The apparatus of claim 10, wherein the tongue portion is in abutting contact with the heatable object when the magnetic coupler is magnetically coupled to the heatable object.

12. The apparatus of claim 5, wherein the LWMC transmitter and associated electronic circuitry is located within channels or cavities on the trivet.

13. The apparatus of claim 4, further comprising an antenna associated with the heater and facilitating communication between the LWMC transmitter and the LWMC receiver, and wherein a housing of the magnetic detachable coupler has a length sufficient to allow positioning of the transmitter within the housing at a location which is within a reception area of the antenna.

15. The apparatus of claim 4, further comprising adhesive means attached to the coupler, permitting the LWMC transmitter to be attached to non-metal heatable objects.

16. The apparatus of claim 5, wherein heater comprises an induction heating unit, and wherein the trivet includes indicating means showing a user when the trivet is properly positioned within a magnetic field of the induction heating unit.

17. The apparatus of claim 16, wherein the indicating means also displays whether the induction heating unit is currently heating the heatable object.

18. The apparatus of claim 1, wherein the LWMC transmitter has an electronic memory capable of storing electronic information pertaining to the heating history previously experienced by the heatable object, the LWMC transmitter being operable to transmit the information when interrogated by the LWMC receiver, and the transmitter also being operable to store updated information received by the transmitter.

19. The apparatus of claim 1, wherein one or more of the parameters of the heatable object is temperature, and further comprising a temperature-sensitive switch.

20. Apparatus for measuring and controlling the temperature of a heatable object used to warm or cook food, comprising:
a magnetic induction heater including a magnetic field generator for generating a magnetic field, the heater having a LWMC receiver associated with it;
the heatable object including a LWMC transmitter; and
the heater having a microprocessor operably connected with the LWMC receiver for initiating the heating of the object only upon placement of the object proximal to the heater and in a position for LWMC communication between the transmitter and the receiver, and for controlling operation of the heater in response to information received from the LWMC transmitter.

21. The apparatus of claim 20, wherein the heatable object includes a food-holding container and an induction heating element.

22. The apparatus of claim 21, wherein the induction heating element comprises a pellet.

23. The apparatus of claim 20, wherein the microprocessor is operable to initiate different heater operation sequences in response to the information received from the LWMC transmitter.

24. A method of heating an object containing food, comprising the steps of:
providing a magnetic induction heater including a magnetic field generator for generating a magnetic field, the heater having an LWMC receiver associated therewith;
providing an object to be magnetically heated, including an induction heatable element and an LWMC transmitter;
placing the object proximal to the heater in a location for magnetic induction heating of the element and in a position for LWMC communication between the transmitter and the receiver; and
initiating the heating of the object and controlling the operation of the heater in response to the placement of the object and receipt of information from the LWMC transmitter.

25. The method of claim 24, wherein the initiating and controlling step is carried out by a microprocessor programmed to initiate different heater operation sequences in response to information received from the transmitter.

26. A food delivery system, comprising:
a food-holding container including an induction heatable element;
a magnetic induction heater including a magnetic field generator for generating a magnetic field;
the heater being operable to heat the element while the element is magnetically coupled with the magnetic field and the element remains within the container; and
a temperature controller operable to control the temperature of the element during the course of heating of the element, including a detector operable to detect an induction heater circuit parameter whose magnitude is dependent upon the impedance presented by the heating element when the element is magnetically coupled with the magnetic field, and control circuitry operable to alter the magnetic field strength of the magnetic field in response to the magnitude, or rate of change of the magnitude, of the detected parameter, during the course of heating;
wherein the temperature controller communicates with the heater using LWMC magnetic communication.

27. Apparatus for measuring and controlling the temperature of an object to be heated used to warm or cook food, comprising:
an LWMC transmitter operably connected to the heatable object;
an LWMC receiver associated with a heater,
a transmitting coil for receiving a sine wave modulated signal and for transmitting the signal over a magnetic field;
a receiving coil for receiving the sine wave modulated signal transmitted by the transmitting coil;
electronic circuitry for demodulating the signal received by the receiving coil; and
a processor for extracting the temperature of the heatable object from the pulse width of the demodulated signal;
wherein the transmitter and the receiver communicate using LWMC.

28. A detachable apparatus for measuring the temperature of an object to be heated, providing for closed-loop heating control, comprising:
an item of cookware to be heated, the cookware item having a LWMC transmitter associated with it, the transmitter being capable of communication with a LWMC receiver in communication with heating controls; and
a magnetic detachable coupler carrying the transmitter, the coupler permitting removable attachment of the coupler to the heatable object.

29. The detachable apparatus of claim 28, wherein the heating control employs magnetic induction heating.

30. The apparatus of claim 1, further comprising a distribution system of gain and filtering comprising a capacitor in parallel with an antenna coil which tunes the antenna as a L-C parallel resonant circuit at the LWMC frequency, enabling selection of desired induction field signals for an induction heater associated with the LWMC transmitter and the LWMC receiver, and enabling rejection of induction field signals associated with adjacent induction heater units.

31. The apparatus of claim 1, further comprising a transmission modulation and demodulation system for enabling the LWMC receiver to sufficiently differentiate the LWMC transmitter from transmitters associated with adjacent heater units, whereby the system envelope-detects a received signal using a peak detector that follows the temperature modulation, but filters out the LWMC carrier frequency associated with transmitters of the adjacent heater units.

32. The apparatus of claim 2, further comprising a protection circuit designed to avoid damaging the LWMC transmitter in the event that the induction heater is connected to a power source greater than the heater is designed for, the protection circuit comprising a power-deriving coil, a rectifier, and a voltage pre-regulator.

33. Apparatus for measuring and controlling the temperature of a heatable object used to warm or cook food, comprising:
a LWMC transmitter operably connected to the heatable object, for receiving and transmitting information concerning one or more parameters describing the heatable object; and
a LWMC receiver associated with an induction heater, the LWMC transmitter communicating information concerning one or more of the heatable object parameters to the LWMC receiver, and the LWMC receiver communicating controls based on the one or more heatable object parameters to the heater;
an induction heater generating an induction field, and a power pickup coil receiving energy from the induction field and powering a temperature sensor coupled to a low frequency oscillator and an amplifier, the oscillator generated a modulated signal amplified by the amplifier and used to drive a low frequency magnetic field transducer coil for generating long wave magnetic communication.

34. The apparatus of claim 33, wherein the transducer coil includes a ferrite core.

35. The apparatus of claim 33, further comprising an induction unit including the induction heater and a receiving coil for receiving and transmitting induction heating-related data to an induction unit control processor.
